(19) United States
(12) Patent Application Publication
(10) Pub. No.: US 2017/0081145 A1
(43) Pub. Date: Mar. 23, 2017

(54) Apparatus for Managing Personal Electronic Accessory Cords

(71) Applicant: Kevin Thomas Cayton, Stillwater, OK (US)

(72) Inventor: Kevin Thomas Cayton, Stillwater, OK (US)

(21) Appl. No.: 14/857,012

(22) Filed: Sep. 17, 2015

(51) Int. Cl. B65H 75/06; H04R 1/10

(52) U.S. Cl. CPC B65H 75/06; H04R 1/1033

(57) ABSTRACT

An apparatus for managing personal electronic accessory cords including, but not limited to, headphone cords comprises of a body 1 with a length of greater measurement than its width and containing an assortment of holes offset from the body's outer edge and connected to the outer edge by way of a guide-slot 2,3,8,9 through which a cord may be passed and secured into the hole (known as cord-locks). The apparatus 1 also contains an assortment of recesses 4-7 in the outer perimeter of the body's length and width edges (known as wrap guides). The cord 11 to be managed can be attached to the apparatus 1 by being passed through the pair of cord locks on opposite ends of the body's length. The cord's main length is then wrapped around the body's longest dimension in the corresponding wrap guides 4,5 and then micro-adjusted around the body's shorter dimension using the other wrap guides 6,7 before the remaining end(s) of the cord are secured in the remaining cord locks 8,9.

### BACKGROUND OF THE INVENTION

This invention relates to the field of management and tangle prevention of various cords used in accessory to personal electronic devices including but not limited to headphone cords, USB cords, and battery charger cords; relating more particularly to the management of cords by means of an apparatus capable of remaining attached to said cord whether in use or not while also allowing for an entire cord to be most conveniently managed.

It should be noted prior to further explanation that use of the words “first,” “second,” “third,” and the like, if found in the descriptions herein are meant to differentiate between similar elements for ease of understanding and do not necessarily indicate a chronological order. For a specific example, the description will discuss various central axes of an embodiment of the invention referring to them as “first,” “second,” and “third,” this does not mean that the axes may only be denoted in that order. Instead they may be denoted in any order or individually, thus the terms are only influential in separating the elements in terms of description. Also, the terms “include,” “have,” “comprise,” and the like, as well as any of their variations, are meant to be non-exclusive inclusions, in the sense that an apparatus may be composed of a certain set of features yet not limited to those features. Furthermore, the terms “cable” and “cord” are used interchangeably and are meant, in the circumstances of these descriptions, to identify any personal electronic accessory cord or cable that could be used with an embodiment of the invention. The cord that will be used as an example for the purposes of the drawings and descriptions is a headphone cord that divides part way up its length into two separate cords each going to its own individual earphone.

The Loh U.S. Pat. No. 7,712,696 B2 teaches an apparatus consisting of a strap around which the headphone cord is wrapped. It does not teach an apparatus that utilizes its longest dimension as the primary cord-wrapping surface; nor does it teach an apparatus that can accommodate a headphone cord with earphones of any shape.

The Sween U.S. Pat. No. 7,610,661 B2 teaches a device that can attach to a headphone cord and wrap and store the cord, however it, also, does not teach an apparatus that utilizes its longest dimension as the primary cord-wrapping surface; nor does it teach an apparatus that holds the length of cord just below the headphones allowing to accommodate a cord with earphones of any shape.

### BRIEF SUMMARY OF THE INVENTION

An embodiment of this invention would fulfill the task of most conveniently managing personal electronic accessory cords in a way that allows the apparatus to attach to the cord whether the apparatus is being used for cord storage or not while also allowing the apparatus to store headphone cords with earphones of any shape.

The advantages of the invention utilizing its longest dimension as the primary cord-wrapping surface are the user needing to make less passes to wrap up the length of the cord and more length of the cord being spread out over the length of the apparatus, which results in a less bulky feeling to the wrapped and stored cord.

One object of the invention is to provide an apparatus for managing personal electronic accessory cords by means of wrapping the cord systematically about the apparatus itself while maintaining the ability to attach to a cord, wrap, unwrap, unattach, and reattach to another cord easily.

It is a further object of the invention for the apparatus to be able to be attached to a cord and remain attached to said cord whether it is wrapped for storage or unwrapped and in use, such that the apparatus could remain attached to the cord indefinitely if desired.

It is a further object of the invention for the apparatus to utilize its longest dimensional axis for storing the majority of the cord and its second longest dimensional axis for more precise adjustments of wrapped cord length.

It is a further object of the invention for the apparatus to attach to the cord by means of cord sized holes connected to the outer edge of the apparatus by guide-slots through which the cord can be passed into and held in place by the friction of the material, such that any section of any cord could be attached to the apparatus so long as the cord itself fits snuggly in the hole it is to be held in, thus allowing the apparatus to hold headphone cords with earphones of any shape, as well as enabling the apparatus to hold other cords such as USB, audio, and charging cables to name a few, regardless of the shape and size of the cable's connection.

### BRIEF DESCRIPTION OF DRAWINGS

It should be noted prior to an explanation of the drawings that use of the terms “top,” “bottom,” “front,” “back,” “side,” “left,” “right,” “over,” “under,” “above,” “below,” and any other respective location identifiers, if used in the descriptions herein, are meant purely as terms for descriptive purposes and do not represent permanent relative positions. These terms are used to simplify the description given the perspectives of the associated drawings. When used, an embodiment of the invention could be manipulated from a variety of orientations and consequently the terms given should be interchanged to apply to the circumstance.

FIG. 1 is an elevation view of the front of an apparatus according to an embodiment of the invention.

FIG. 2 is an elevation view of the left side of an apparatus according to an embodiment of the invention.

FIG. 3 is an elevation view of the front of an apparatus according to an embodiment of the invention as a headphone cord is attached to the apparatus and beginning to be wrapped around the length of the apparatus. For simplicity the majority of the headphone cord, including headphones, has been omitted from the drawing and it should be noted that the cord does not necessarily end where the drawing of the cord ends.

FIG. 4 is an elevation view of the front of an apparatus according to an embodiment of the invention where the headphone cord from FIG. 3 has been completely wrapped around the apparatus and secured.

While in the drawings and descriptions a headphone cable is given for example of the cord to be managed it must be stated that any variety of electronic accessory cords may be used in the same manner presented. While some cords may require a slightly different process of use, for sake of simplicity these processes will not be described in detail as they differ so slightly from the descriptions provided that their processes would be considered obvious. It should also be stated that some aspects of these drawings are not necessarily to scale, some elements may be enlarged compared to others to show detail and provide better understanding of an embodiment of the invention. The same reference indicia in different figures represent the same element.

### DETAILED DESCRIPTION OF INVENTION

Along with the recent explosion of popularity in portable electronic devices such as personal music players, cellular phones, laptop computers, tablets, and the like, there has also been a surge in the number of corded accessories used with these devices. These accessories include but are not limited to personal headphones, charging cables, and USB cables. A need for a convenient, reliable, and useful system to manage these accessories has become increasingly apparent. Without such a system these corded accessories quickly become a great heap of tangled wires, causing loss of time as one untangles them and occasionally even leading to the breakage of the cords themselves. Unmanaged cables also present the safety hazards of snagging on items or tangling themselves around people, children, and pets. This invention provides an apparatus intended for managing said cords.

The apparatus 1 of an embodiment of the invention is an object with a shape that could generally be described as a rectangular prism in the sense that it has a length and a width of different values. The apparatus 1 contains an assortment of holes sized to fit cords snuggly that are extended past the edge of the apparatus by guide-slots through which the cords can be passed 2,3,8,9 as a means of securing cords. The apparatus 1 also contains indentions 4-7, which serve as way of facilitating wrapping of the cord. The apparatus 1 is sized to fit comfortably into the average pant leg pocket, and can be composed of any number of materials including plastics, rubbers, natural fibers, and some metals.

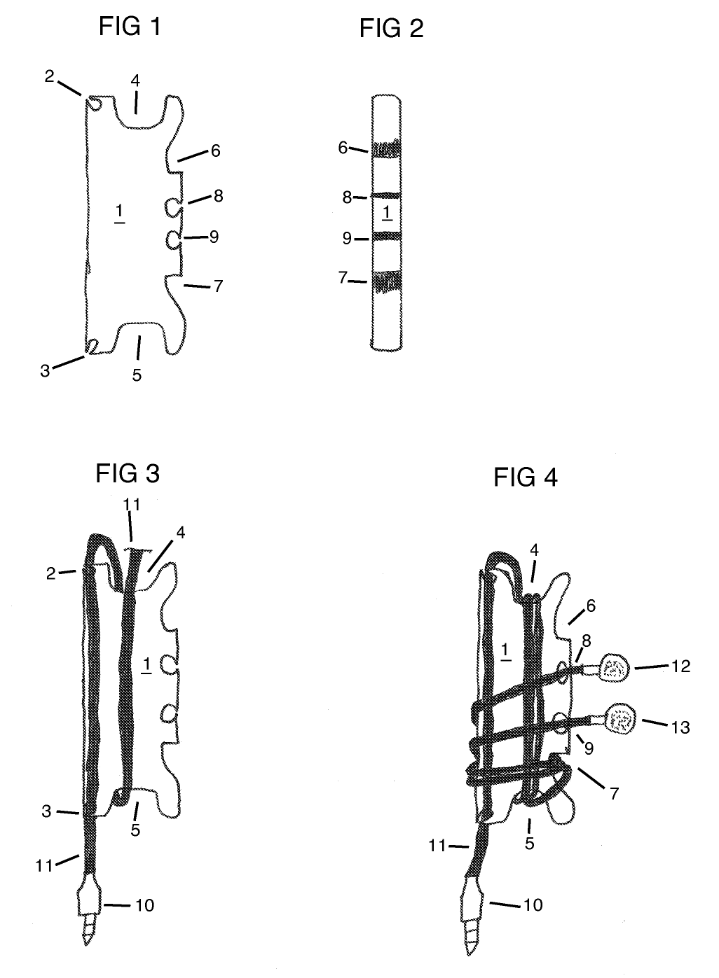

Referring directly to the figures, FIG. 1 is an elevation view of the front of apparatus 1 according to an embodiment of the invention. Apparatus 1 could theoretically be bisected along three axis lines. The first axis line runs through the center of apparatus 1 across its width, spanning from the left side to the right side of FIG. 1 and will hereby be referred to as the central width axis. A second axis line runs through the center of apparatus 1 across its length, spanning from the top to the bottom of FIG. 1, and will hereby be referred to as the central length axis. The final axis line runs through the center of apparatus 1 across its depth, spanning from the left side to the right side of FIG. 2. It should be noted that the central length axis must have a greater distance measurement than the central width axis.

FIG. 1 shows that apparatus 1 has a small hole inset in the top left corner, 2, and a similar hole inset in the bottom left corner, 3. FIG. 1 also shows another similar hole inset just above the central width axis, 8, and a fourth similar hole just below the central width axis, 9. These holes all: pass completely through the depth of apparatus 1, are inset slightly from the outer edge of apparatus 1, and are connected to a small opening, or guide-slot, that passes from the outer edge of apparatus 1 to the nearest point on each hole, covering the entire depth of apparatus 1, such that any part of a cord 11 may be slid through the guide-slot into the hole to be held in place. The hole on the top left and the hole on the bottom left, 2 and 3 respectively, will hereby conjointly be referred to as the “plug-end cord locks,” as they are intended to hold in place the portion of headphone cord 11 nearest to the plug 10. While the holes on the right side just above and below the central width axis, 8 and 9 respectively, will hereby conjointly be referred to as the “earphone end cord locks,” as they are intended to hold in place the portion of headphone cord 11 nearest to each individual ear bud 12 and 13.

In addition to the sets of holes previously described, FIG. 1 also presents an assortment of indentions, or recesses, in the edges of apparatus 1. Note first the broad indention that sits on the top, 4, as well as its opposite indention that sits on the bottom, 5; these indentions will hereby be conjointly referred to as the “vertical wrap guides.” The indention that sits on the right edge above the central width axis, 6, and the indention that sits on the right edge below the central width axis, 7 will hereby be conjointly referred to as the “horizontal wrap guides.”

FIG. 2 is an elevation view of apparatus 1 of an embodiment of the invention from the right side in relation to the front pictured in FIG. 1. From the perspective of FIG. 2 can be seen both horizontal wrap guides 6 and 7 as well as both earphone end cord locks 8 and 9.

FIG. 3 is an elevation view of the front of apparatus 1 according to an embodiment of the invention, utilizing the same perspective as FIG. 1, however FIG. 3 shows a length of headphone cable 11 as well. The length of cable 11 presented in FIG. 3 is the portion that lies nearest to headphone plug 10. FIG. 3 depicts that a portion of headphone cable 11 just above headphone plug 10 has been slid through the slit and into the hole of the plug-end cord lock 3 on the bottom of apparatus 1. Headphone cable 11 has then, in the same manner, been slid through the slot and into the hole of the plug-end cord lock 2 on the top of apparatus 1, at the nearest possible point on headphone cord 11 such that there is no excess cord between the two plug-end cable locks 2 and 3. From there headphone cord 11 has been wrapped down around the back of apparatus 1 and through the bottom vertical wrap guide, 5. Cord 11 was then wrapped tightly around the bottom vertical wrap guide, 5 and brought up towards the top vertical wrap guide, 4, thus utilizing the longest dimension of apparatus 1 as the primary length for managing accessory cord 11.

FIG. 4 portrays the same view and image as FIG. 3 with the exception that the remaining length of headphone cord 11 has been completely wrapped and secured around apparatus 1 as per the recommended use of an embodiment of the invention. FIG. 4 shows that the majority of remaining headphone cord 11 has been wrapped tightly around both vertical wrap guides 4 and 5 until a length has been reached where an additional wrap would render the remaining cord 11 too short to be passed through the earphone end cord locks 8 and 9. From this point the remaining headphone cord 11 can be passed through either the top or bottom horizontal wrap guide, 6 or 7 respectively, whichever is closest to the final vertical wrap guide, 4 or 5, that cord 11 has passed through. In the example of FIG. 4 cord 11 had reached the bottom vertical wrap guide 5 and consequently was passed through the bottom horizontal wrap guide, 7. Cord 11 was then wrapped tightly around the width of apparatus 1, utilizing the second longest dimension of apparatus 1 as a secondary length for managing cord 11. This allows for a length of cord 11 to be achieved where each section of cord 11 just below either earphone, 12,13, can be passed through the respective slot and secured into its individual earphone end cord lock 8,9.

It calls to be stated that the indentions that make up the vertical and horizontal wrap guides, 4, 5, 6, and 7, can be shaped complimentary to the shape of the apparatus 1 itself. For specificity's sake it remains that vertical wrap guides 4 and 5 will always be separated by the longest dimensional side of apparatus 1. Horizontal wrap guides 6 and 7 will always lie on the edge of the longest dimension of apparatus 1, thus they direct cord 11 across the second longest dimension of apparatus 1, leaving the shortest dimension to be the depth of apparatus 1, in the case of the embodiment pictured. It should also be maintained that the earphone end cord locks 8 and 9 will always be equal distance on either side of a line across the width of apparatus 1 that falls halfway between horizontal wrap guides 6 and 7. Beyond these stated requirements it should not be held necessary that the elements listed in this description be assembled in any specific relative location or design to form an embodiment of the invention.

1. An apparatus for managing personal electronic accessory cords including, but not limited to, headphone cords, wherein the apparatus comprises a body existing within an outer perimeter that is sized to fit comfortably in the average pant leg pocket, and said embodiment of the invention:
has one longer dimension (length) and one shorter dimension (width) in respect to each other, with the depth measurement of the body being unimportant;
contains an assortment of holes which pass completely through the depth of the body, are sized to snuggly fit a personal electronic accessory cord, are set slightly in from the outer perimeter of the body, and are connected to the outer perimeter of the body by means of a guide-slot;
contains an assortment of recesses that lie along the outer perimeter of the body running parallel to either the width or the length dimensions of the body and passing entirely through the depth of the body.

2. The apparatus of claim 1 wherein the body of the invention is composed from any number of materials so long as is provided enough flexibility for the cord to be pushed through a guide-slot and still held in place within the adjacent hole and also enough rigidity that the body of the object can support the forces imposed on it in the wrapping and storage of the cord without folding over or failing.

3. The apparatus of claim 1 wherein one cord sized hole and guide-slot combination is located near one end of the body's length and another cord sized hole and guide-slot combination is located at the opposite end of the body's length, with the locations of the two in respect to the body's width being unimportant.

4. The apparatus of claim 1 wherein at least one pair of cord sized hole and guide-slot combinations lie on at least one length (longer) side of the body.

5. The apparatus of claim 1 wherein at least one recess lies along at least one width (shorter) side of the body.

6. The apparatus of claim 1 wherein at least one recess lies along at least one length (longer) side of the body.
